(19) United States
(12) Patent Application Publication
(10) Pub. No.: US 2005/0074659 A1
(43) Pub. Date: Apr. 7, 2005

(54) Solid oxide fuel cell stack configuration

(76) Inventors: Stephen Roger Maitland Thomas, Victoria (AU); Anthony Graham O'Hara, Victoria (AU); Darren Bawden Hickby, Victoria (AU); Yeesan Le, Victoria (AU); Jeremy Carl Lawrence, Victoria (AU); Arthur Kistas, Victoria (AU)

Correspondence Address: BIRCH STEWART KOLASCH & BIRCH, PO BOX 747, FALLS CHURCH, VA, 22040-0747, US

(21) Appl. No.: 10/482,836

(22) PCT Filed: Jul. 12, 2002
(86) PCT No.: PCT/AU02/00941

(30) Foreign Application Priority Data
Jul. 13, 2001 (AU) PR 6364

(51) Int. Cl. H01M 8/24; H01M 8/12; H01M 2/08

(52) U.S. Cl. 429/38; 429/32; 429/35; 429/33

(57) ABSTRACT

A fuel cell stack (2) comprises a stack (3) of alternating solid oxide fuel cell and gas separator plates within a housing (4). Each fuel cell plate has apertures therethough aligned with corresponding apertures through adjacent separator plates. A first aligned series of apertures in the fuel cell and separator plates opens to the anode side of each fuel cell to form a first manifold (5) for incoming fuel gas. A second aligned series of apertures in the fuel cell and separator plates opens from the anode side of each fuel cell to form a second manifold (6) for exhaust fuel gas. A third manifold (7) for in coming air is formed between the stack (3) and housing (4) and opens to the cathode side of each fuel cell. A fourth manifold (8) for exhaust air is formed between the stack (3) and housing (4) and opens from the cathode side of each fuel cell. In a preferred embodiment a third aligned series of apertures in the plates opens from the anode side of each fuel cell to form a second exhaust fuel gas manifold (6) and a second exhaust air manifold (8) is formed between the stack (3) and housing (4). Sliding fibrous seals (9) are provided are provided between the stack (3) and housing (4) to separate the air manifolds (7) and (8).

### FIELD OF THE INVENTION

The present invention relates to a solid oxide fuel cell (SOFC) stack configuration. In particular, the invention concerns the arranging of planar SOFCs into a stack with improved manifolding.

### BACKGROUND OF THE INVENTION

While planar solid oxide fuel cells are a proven technology in terms of individual cells, the problem of combining the individual cells into stacks, having collectively useful power at reasonable cost and with acceptable durability, has proven to be an elusive goal to those skilled in the art. Specific difficulties include providing satisfactory fuel and oxygen-containing gas inlet and exhaust manifolding systems as well as reliable sealing of the system at a commercially acceptable cost while at the same time providing a structure that is robust to thermal cyling.

There have been many different patent proposals for manifolding fuel cell systems comprising alternating fuel cell members and gas separator members, both for SOFCs and other fuel cell technologies such as molten carbonate fuel cells. Many such proposals are for fully internally manifolding the fuel gas and oxygen-containing gas supply and exhaust, that is all of the manifolds pass through apertures in the fuel cell members and the gas separator members, requiring reliable and complex sealing arrangements around each aperture to ensure the fuel gas and oxygen-containing gas remain separated from each other at all times during operation and thermal cycling of the fuel cell stack.

By way of example only, the following patent specifications are all directed to internally manifolded fuel cell systems: U.S. Pat. Nos. 6,103,415, 6,040,076, 5,945,232 and 4,963,442, EP 959511 and 459940, WO 95/16287 and 92/09116 and JP 2001-202984, 06-275304 and 04-149966.

Other internally manifolded fuel cell systems are proposed in U.S. Pat. Nos. 5,288,569 and 5,230,966, EP 425939 and JP 08-190921.

In contrast, an externally manifolded proton exchange membrane fuel cell is proposed in WO 01/99219. U.S. Pat. No. 5,688,610 is also directed to external manifolding, for planar SOFC stacks. In this proposal fuel gas and exhaust fuel gas are directed to and from the stacks by respective manifolds on the sides of the stack and exhaust air gas is directed from plural stacks by a common manifold, but incoming air is freely directed to the stacks from within a housing enclosing all of the stacks.

In the prior art discussion of U.S. Pat. No. 5,688,610, similar proposals to that in the patent are said to be disclosed in DE 4,324,907 and EP 450336.

Although U.S. Pat. No. 6,040,076 referenced above is directed to an internally manifolded gas separator plate, it also mentions internal manifolding being provided for fuel gas or oxidant communication to one side of the gas separator plate while the other of fuel gas or oxidant gas is provided to the opposite side of the gas separator plate through an external manifold. However, there is no suggestion of how this is achieved.

It is an aim of the present invention to simplify the manifolding of an SOFC stack, and to thereby simplify the sealing of the stack.

### SUMMARY OF THE INVENTION

According to the invention there is provided a fuel cell stack comprising alternating solid oxide fuel cell plates and gas separator plates stacked face to face within a housing, each of said fuel cell plates having an electrolyte layer with an anode layer on one side of the electrolyte layer and a cathode layer on an opposite side of the electrolyte layer, wherein each of said fuel cell plates has apertures therethough aligned with corresponding apertures through adjacent gas separator plates, a first aligned series of said apertures in the fuel cell plates and the gas separator plates opening to the respective anode side of each of the fuel cell plates to form a first manifold through which incoming fuel gas is distributed and a second aligned series of said apertures in the fuel cell plates and the gas separator plates opening from the respective anode side of each of the fuel cell plates to form a second manifold through which exhaust fuel gas is discharged from the stack, and wherein a third manifold is formed between the plates and the housing and opens to the respective cathode side of each of the fuel cell plates for distributing oxygen-containing gas to the fuel cell plates and a fourth manifold is formed between the plates and the housing and opens from the respective cathode side of each of the fuel cell plates for discharging exhaust oxygen-containing gas from the stack.

Provision of fuel inlet and exhaust manifolds internally of the plates and oxygen-containing gas (usually air) inlet and exhaust manifolds externally of the plates can optimise the structure of the plates from both economic and power producing perspectives. If the manifolds were fully internalised, the construction of the plates would be more complex and a significant portion of the plates would need to be dedicated to the formation of the respective manifolds, i.e. each plate would have an increased aperture area compared to the plates in the stack of the invention. Relatively increasing the functional area of the plates allows for maximised generation of electric current from the stack. Externalising the air manifolds simplifies the inter-plate sealing since there are no air apertures through the plates around which individual seals must be provided, and providing the air manifolds between the plates and the housing can allow for simple seals between the air manifolds. However, internalising the fuel manifolds also means the overall structure may be robust since external connections which may otherwise be subject to fatigue or leakage are minimised.

There may be more than one incoming fuel gas manifold and/or more than one exhaust fuel gas manifold to enhance fuel gas flow through the stack. In a preferred embodiment, a third aligned series of said apertures in the fuel cell plates and the gas separator plates opens from the respective anode side of each of the fuel cell plates to form a further exhaust fuel gas manifold. Preferably, the first and second manifolds and the further exhaust fuel gas manifold are angularly spaced about the fuel cell plates and the gas separator plates. In this arrangement, the fuel cell plates and the gas separator plates may each be generally circular with three lobes extending therefrom through which the apertures of the first, second and third aligned series of apertures respectively extend. Advantageously, each of the apertures of the first series of apertures has a greater cross-sectional area than each of the apertures of the second and third series of apertures.

The incoming and exhaust fuel gas manifolds must be sealed to prevent leakage of the fuel gas into the cathode sides of the fuel cell plates, and advantageously a gas-tight seal extends around each of the apertures of the series of apertures, between said opposite side of each fuel cell plate and the adjacent gas separator plate. The gas-tight seals may take any suitable form, including gasket seals and opposed formations ill the plates. In one embodiment, each of said gas-tight seals comprises a groove having a glass sealant in the bottom thereof in an upwardly facing surface of one of said fuel cell plate and said adjacent gas separator plate and a rib on the oppositely facing surface of the other of said fuel cell plate and said adjacent gas separator plate and said rib projects into contact with the glass in the groove. Conveniently, the rib, or the plate from which the rib protrudes closes the open top of the groove to retain the sealant in the groove. Conveniently, the groove is formed between a pair of spaced ribs extending around the respective aperture in said upwardly facing surface.

It is important that the incoming and exhaust air is prevented from leaking into the anode sides of the fuel cell plates, and there is advantageously provided a respective gas-tight seal between said one of each fuel cell plate and the adjacent gas separator plate around said plates outwardly of the apertures of said series of apertures through said plates. This gas-tight seal may extend wholly around the periphery of the one side of the respective fuel cell plate and adjacent gas separator plate, but conveniently it is also used to direct the fuel gas flow across the anode.

The same options for the gas-tight seal between the one side of each fuel cell plate and the adjacent gas separator plate apply as for the gas-tight seal that extends around the apertures between the opposite side of each fuel cell plate and the adjacent gas separator plate described above.

The fuel cell and gas separator plates of the stack are preferably physically in a columnar series and enclosed within a cylindrical housing, with the walls of the housing at least partially defiling the inlet air and exhaust air manifolds. The air manifolds, being external to the fuel cell plates and the separator plates, are also defined by peripheral portions of the fuel cell plates and the gas separator plates and seals between the plates.

The inlet air and exhaust air manifolds formed between the plates and the housing are preferably separated by seals, most preferably simple fibre seals, extending along the stack between the plates and the housing. There may be a small degree of gas leakage between the inlet air and exhaust manifolds past the seals, but this need not significantly affect the performance of the stack.

There may be more than one inlet air manifold and/or more than one exhaust air manifold to enhance the flow of the oxygen-containing gas through the stack. In a preferred embodiment, a further exhaust air manifold opening from the respective cathode side of each of the fuel cell plates is formed between the plates and the housing. In the preferred embodiment described above, the three air manifolds are partly defined by the portions of the plate peripheries between the three lobes through which the apertures of the first, second and third aligned series of apertures respectively extend. Advantageously, the fuel gas flow across the anode layer of each of the fuel cell plates is in counter-flow to the air flow across the cathode side of the fuel cell plates, in which case the inlet air manifold is conveniently defined between the lobes through which the apertures of the second and third series of apertures extend, while the two exhaust air manifolds are defined between the lobes through which the apertures of the first series of apertures extend and the apertures of the second and third series of apertures, respectively. Advantageously, the inlet air manifold had a greater angular extent than each of the two exhaust air manifolds.

The stack may be arranged so that the air and fuel gases pass through the manifolds in co-flow or counter-flow.

The current may be passed along the stack from, for example, an anode of one of the cell plates, via a fuel side current collector between the plates either through or around an adjacent separator plate, to an air side current collector at a cathode of an adjoining fuel cell plate. If the current passes around the separator plate, it may do so by means of conductive wires or foils or some other means. If the current passes through the separator plate, it may do so either by use of the bulk material of that plate, or by specific conductive elements in the plate.

Gas flow control formations may be provided on the plates between each adjacent pair of said fuel cell plates and said gas separator plates, and such gas flow control formations may also act as current collectors. They may also act as spacers to control the spacing of the respective separator plate from an adjacent fuel cell plate.

The fuel cell plates and the gas separator plates are preferably both constructed of ceramic material such as zirconia, but the gas separator plates may be formed of a suitable metal such as self-aluminising stainless steel.

### BRIEF DESCRIPTION OF THE DRAWINGS

One embodiment of a fuel cell stack in accordance with the invention will now be described, by way of example only, with reference to the accompanying drawings, in which:

FIG. 1 is a plan view of the fuel cell stack;

FIG. 2 is an exploded schematic perspective view looking downwards and illustrating the general orientation of cell plates and gas separator plates within the stack shown in FIG. 1;

FIG. 3 is a schematic perspective view looking upwards at the cell plates and gas separator plates in the same exploded positions shown in FIG. 2;

FIG. 4 is a perspective view of the top side of one of the cell plates as shown in FIG. 2;

FIG. 5 is a cut-away perspective view of the top side of one of the gas separator plates shown in FIG. 2;

FIG. 6 is a cut-away underside view of the separator plate shown in FIG. 5; and

FIG. 7 is a diagrammatic cross-sectional view through a portion of a gas seal assembly between the plates shown in FIGS. 1 and 2.

### DETAILED DESCRIPTION OF EMBODIMENTS OF THE INVENTION

Referring to FIGS. 1, 2 and 3 a solid oxide fuel cell stack assembly 2 comprises a stack 3 of alternating fuel cell components, in the form of cell plates 10 and gas separator plates 30 held within a tubular housing 4. All of the cell plates 10 are identical and all of the separator plates 30 are identical. Typically there might be 20 to 500 of each of these plates in the stack 3. Fuel gas and air are supplied at one axial end of the stack assembly and exhaust gases are collected at the other end in a co-current manifolding system. Either end is suitable for the supply and exhaust functions, but the manifold system may alternatively be counter-current. In the described co-current embodiment, the fuel and air supplies are both at the bottom and the exhausts are at the top, but in many circumstances it is preferred for the fuel to be supplied from the bottom and the air to be supplied from the top in a counter-current arrangement. Alternatively, all of the gas supplies and exhausts may be at the same end.

Referring to FIGS. 1 to 6, each cell plate 10 has a substantially central, square anode layer on an upper face of the electrolyte-based cell plate and a substantially central, square cathode layer on a lower face of the cell plate to form a substantially square fuel cell 12.

The cell plates 10 and separator plates 30 have the same outer shape, which could be described as generally trilobular, or part way between a circle and a triangle. The shape could alternatively be described as generally circular with three rounded lobes extending therefrom. Two of the lobes 74 and 76 are the same size and the third lobe 72 extends about 50% further than the others circumferentially around the periphery of the plate. At each lobe 72, 74 and 76 a kidney shaped aperture (numbered 14, 16 and 18 in the cell plate and 15, 17 and 19 in the separator plate respectively) extends through the plate. The larger lobes 72 carry the larger apertures 14 and 15. A system of ridge shaped seals on the faces of the plates directs the gas flows within the stack. These seals are described hereinafter in more detail, but it will be appreciated that other types of seals may be utilised, including gasket seals.

Fuel distribution and exhaust collection manifolds 5 and 6, respectively, (FIG. 1) defined by the three aligned series of apertures 14 and 15, 16 and 17, and 18 and 19 in the fuel cell and gas separator plates and formed by interlocking the seal components of the plates 10 and 30, conduct the fuel inlet and exhaust streams past the air side of the plates to the anode side. Air supply and collection manifolds 7 and 8 respectively are created by three volumes formed between the periphery of the stack 3 and the inside wall of the housing 4. Manifold 7 is formed essentially between the lobes 74 and 76 of the plates, and the two exhaust manifolds 8 are formed essentially between the lobes 72 and 74 and the lobes 72 and 76, respectively, of the plates. Inlet air manifold 7 has an angular extent that is about 50% larger than the each of the two exhaust manifolds 8, and is opposite the fuel inlet or distribution manifold 5. Respective elongate fibrous seals 9 extend along the stack adjacent the lobes 72, 74 and 76, between the stack 3 and the inside wall of the housing 4 to separate the air supply manifold 7 from the two air collection manifolds 8. The fibrous seals may permit a degree of leak-age between the manifolds 7 and 8, but this is not likely to be detrimental to the operation of the stack.

The housing 4 is constructed of a suitable heat resistant steel sheet material, which may be lined with a suitable insulating material, and is slid into position over the stack 3 after the plates 10 and 30 have been assembled together.

In operation of the stack, fuel gas flows up through the larger aperture 14 defining an inlet port in each cell plate 10 and (at arrow A) across the face of the fuel cell anode, then divides its flow (arrows B and C) to exit up through exhaust port apertures 17 and 19, respectively, in the adjacent gas separator plate 30. On the opposite face of the cell plate 10 air, which has passed up the side of the stack 3 through the inlet manifold 7 between the stack and the housing, flows in (arrow D) from the periphery of the stack 3 and across the face of the fuel cell cathode, in counter-current to the fuel gas flow across the fuel cell anode, before dividing its flow to exit (arrows E and F) from the periphery of the stack 3 and then continuing up through the exhaust manifolds 8 to the top of the stack.

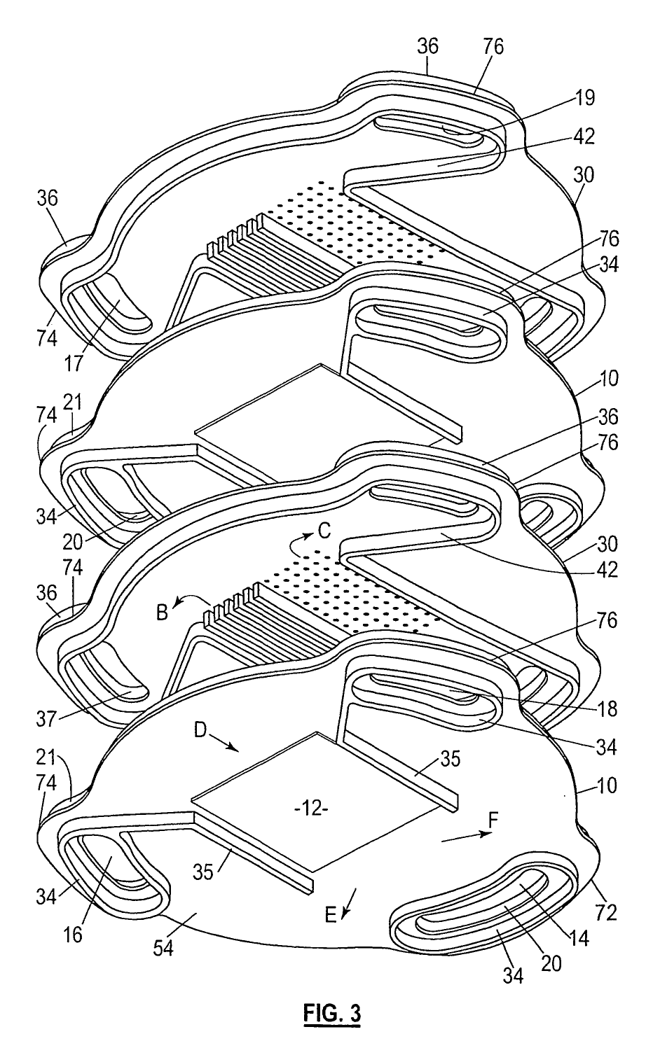

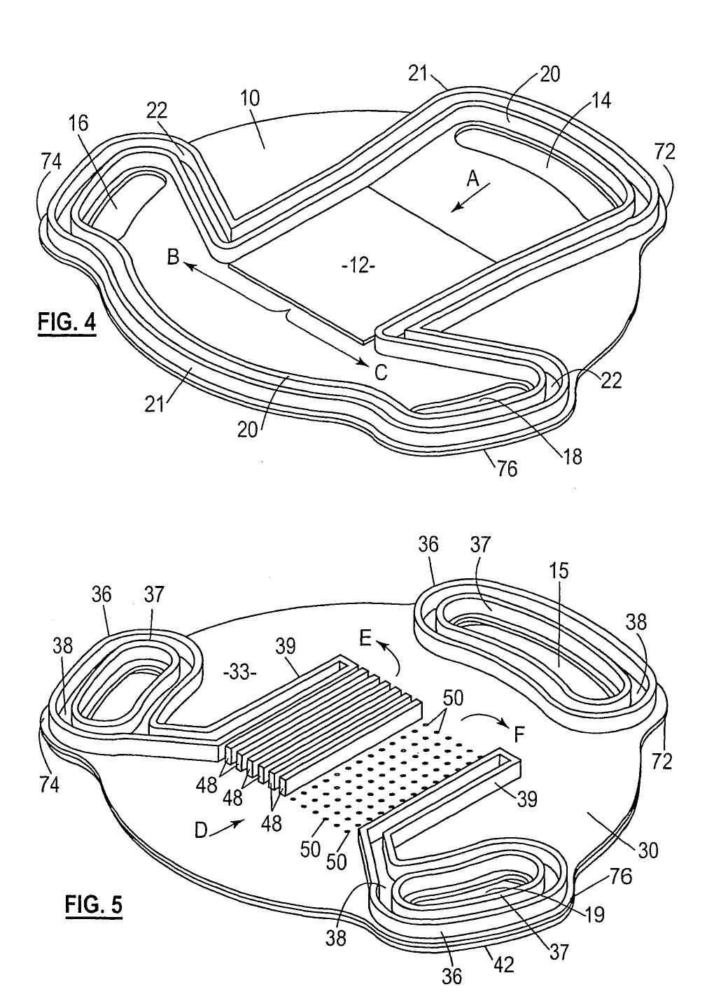

Referring to FIG. 4, the generally planar cell plate 10 used in the stack 3 is shown in greater detail. The square fuel cell 12 on the plate (the anode is visible) has an electrolyte supported structure with the electrolyte material extending out to form the main body of the plate 10. The electrolyte is preferably a yttria stabilised zirconia and suitable 3Y, SY and 10Y materials are known to those in the art. The anode is preferably a nickel-zirconia cermet and the cathode is preferably a conductive perovskite such as lanthanum strontium manganate. The underside of the cell plate 10 and the cathode are visible in FIG. 3.

A pair of parallel ribs 20 and 21 project from the planar surface 24 of the cell plate 10 forming a valley or groove 22 therebetween. The surface 24 is the upper, anode surface of the cell plate when the stack is oriented for use. The ribs are formed of zirconia and may be integrally formed with the main body of the plate or may be formed separately, for example from a screen printed slurry, and be fired into integral relationship with the main body. Each rib 20 and 21 forms a continuous path or closed loop outwardly of the apertures 14, 16 and 18, which pass through the cell plate, and around the perimeter of the region which the fuel gas is permitted to contact. In particular, the closed loop defined by the ribs 20 and 21 is waisted alongside the anode to direct fuel gas from the inlet aperture 14 over the anode.

In all the Figures, the thickness of the plates 10 and 30 and the height of the ribs are shown greatly exaggerated to assist the explanation of the components. In this embodiment the fuel cell 12 is 2500 mm², the cell plate is 150 μm thick and the ribs are approximately 500 μm high, 1 mm wide and approximately 2 mm apart.

On the lower-cathode side 54 of each fuel cell plate 10, as shown in FIG. 3, a respective single rib 34 (that corresponds to the ribs 20 and 21 in term of size and how it is formed) extends around each of the apertures 14, 16 and 18 through the plate. Each of the ribs 34 around the apertures 16 and 18 has an arm 35 that extends inwardly and towards the aperture 14 (but short thereof) alongside the cathode layer of the fuel cell 12 to assist guidance of incoming air over the cathode. One of the ribs 34 is also shown in FIG. 7 and the use of the rib seals is described with reference to that Figure.

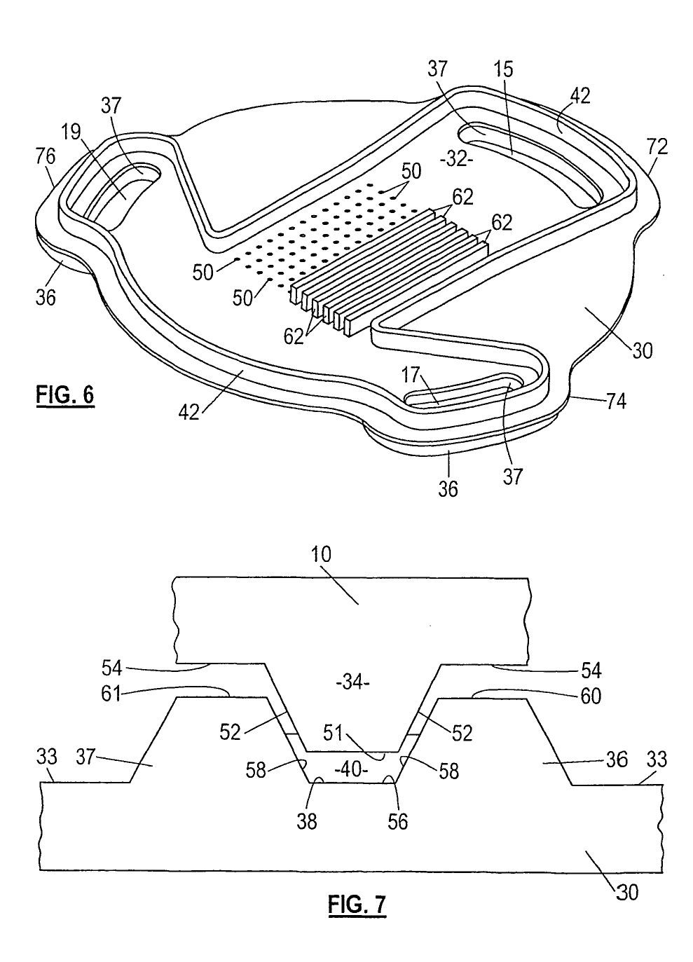

FIGS. 5 and 6 show the planar gas separator plate 30 in greater detail. In FIG. 5, the surface 33 is the upper, cathode-contacting surface of the separator plate 30 when the stack is oriented for use. Respective pairs of parallel ribs 36 and 37 project from the planar surface 33 of the separator plate 30 forming valleys or grooves 38 therebetween. The pairs of parallel ribs 36 and 37 correspond to the ribs 20 and 21 in terms of size, spacing and how they are formed, but extend around the apertures 15, 17 and 19, which pass through the plate 30, to cooperate with the ribs 34 on the cathode-side of the adjacent fuel cell plate 10. The respective ribs 36 associated with the apertures 17 and 19 each have a double-walled arm 39 that is closed at its distal end to cooperate with and receive the arm 35 of the corresponding rib 34.

On the lower, anode-contacting side 32 of each gas separator plate 30, a single rib 42 is shown in FIG. 6 and partly in FIG. 5. The rib 42 corresponds to the ribs 20 and 21 in terms of size and how it is formed, and forms a continuous path outwardly of the apertures 15, 17 and 19 through the plate 30 and around the perimeter of the region that the fuel gas is permitted to contact. The outline of the rib 42 corresponds to the groove 22 between the ribs 20 and 21 on the anode surface of the adjacent fuel cell plate 10 and cooperates with those ribs in forming a seal.

As explained hereinafter, with reference to FIG. 7, glass sealant 40 is used in both of valleys 22 and 38 to form a seal between the ribs.

Each separator plate 30 is conveniently manufactured from a zirconia to substantially match the coefficient of thermal expansion of the main body of the cell plates 10. This greatly minimises thermal stresses in the assembly during start-up, operation and shut-down. The zirconia may be yttria-stabilised, but could be, for example, an alumina-added zirconia with up to 20 wt % alumina.

The zirconia is not electrically conductive, and the separator plate 30 has an array of perforations 50 extending perpendicularly through its full thickness that are filled with an electrically conductive plug material. These perforations may be formed by laser cutting and occupy a region in the plate 30 which is directly opposite the region occupied by the fuel cell 12 in plate 10. The plug material may be metallic silver (commercially pure) which is plated into the perforations by standard plating or printing techniques. Alternatively the perforations may be filled with a silver alloy or a silver composite, such as a composite of silver or silver alloy in glass. Suitable alloying elements or materials include gold, palladium and platinum. Alternatively, the silver may be mixed with stainless steel, for example as powders prior to sintering in the perforations.

The perforations have an average cross-sectional dimension of about 300 μm, and the plug material seals the perforations to present a total cross-sectional area of plug material in the range of 0.2 to 5 mm² per 1000 mm² of the electrode-contacting zone (measured on one side only of the plate 30). The electrically conductive silver based plug which fills each perforation is preferably plated with a protective Ni coating on the anode side and an Ag—Sn coating on the cathode side. The coatings may extend over the entire electrode-contacting zone of the plate. The nickel coating may have an undercoating of Ag to assist the Ni to bond to the separator body, and the Ag—Sn coating may have a SnO₂ surface layer. Such coatings, for example by screen printing of powder materials in a binder and subsequent firing, may act to fill the perforations 50 from the outside so as to ensure that electrically conductive paths are provided via the perforations from one of the outer surfaces to the other outer surface of the gas separator plate.

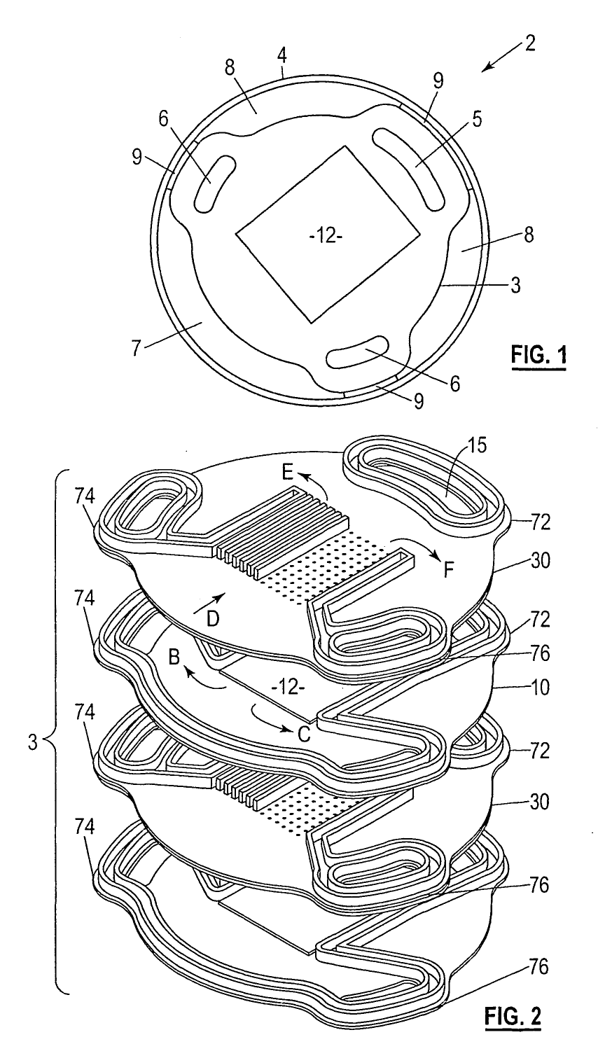

An array of parallel ridges 48 is positioned parallel to the air flow stream in the electrode-contacting zone on the cathode-side 33 of each plate 30. These ridges 48 are each aligned over a corresponding row of perforations 50 and over any Ag—Sn coating. To assist explanation, about half of the ridges 48 have been removed in FIGS. 2 and 5. The ridges 48 perform two major functions. First they provide a conductive path between the plug material in perforations 50 or the Ag—Sn coating and the fuel cell 12. Second they provide physical support to brace the thin and fragile cell plate as well as means for distributing gas flows in the narrow spaces between the cell plates and the separator plates. The ridges 48 thus need to be both electrically conductive and structurally stable. The ridges 48 are approximately 500 μm high and could be made from a conductive perovskite, such as the LSM material of the cathode, optionally with a metallic silver coating about 50 μm thick.

On the underside of plate 30 (ie. surface 32 shown in FIG. 6), the rows of plugged perforations 50 and any Ni coating are covered by an array of parallel ridges 62 that are positioned parallel to the fuel gas flow stream. Again, about half the ridges 62 are cut away in FIG. 6 to assist visualisation of the structure. The ridges 62 perform as a current collector whereby current is conducted between the plug material in the perforations 50 and any Ni coating and the anode. They also provide physical support for the cell plate and additionally provide means for directing and distributing gas flows in the narrow spaces between the cell plates and separator plates. The ridges are approximately 500 μm high and could be formed from the same material as the anode, optionally with an overlay (approx 50 μm thick) of nickel.

Referring to FIG. 7, a pool of glass sealant 40 is located between the ribs 36 and 37 and is pressed into by rib 34. Each rib has a tapered profile with oppositely inclined flanks and a distal surface. A similar arrangement applies between the ribs 20 and 21 and rib 42, but will not be described separately. During manufacture, the glass is introduced as a powder and the stack assembled before the stack is heated to melt the glass in order to form the required seal. Thus, no binder is required. In operation of the stack the glass sealant 40 is fully molten but highly viscous and is retained in the groove 38 by one of the following three options not shown in FIG. 7.

In one embodiment option, the distal surface 51 of the rib 34 contacts the floor 56 of the groove 38 leaving at least one of the flanks 52 of the rib 34 clear of the flanks 58 of the groove and leaving the distal surfaces 60 and 61 of ribs 36 and 37 clear of the basal surface 54 clear of the plate. In this case the glass sealant 40 would be retained by surface tension between the spaced flanks 52 and 58.

In a second, and preferred, embodiment option, the distal surfaces 60 and 61 contact the basal surface 54 leaving at least one of the flanks 52 clear of the flanks 58 and the distal surface 51 clear of the floor 56. In this case the sealant 40 would be retained between the distal surface 51 of the rib 34 and the floor 56, with some displaced outwardly to between the spaced flanks 52 and 58.

In a third embodiment option, both flanks 52 would engage corresponding flanks 58 leaving the distal surfaces 60 and 61 clear of the basal surface 54 and the distal surface 51 clear of the floor 56. In this case the sealant 40 would fill the volume between the distal surface 51 and the floor 56.

The described embodiment provides a stack configuration which is simple to construct and has substantial flexibility in control of the gas flows to, from and over the fuel cell electrodes. It also allows for many alternative forms of electrical current collection. It uses a relatively small number of components and the sliding interfaces provided by the fibrous seals produce much lower stresses during thermal cycling.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

For example, the preferred embodiment has separator plates made from zirconia. Alternatively they may be made from a lanthanum chromite to facilitate electrical conductivity therethrough, or from a self-aluminising stainless steel.

Other aspects of the fuel cell stack described herein are disclosed and claimed in copending International patent applications filed concurrently herewith entitled A Fuel Cell Gas Separator Plate and Seal For A Fuel Cell Stack, respectively claiming priority from Australian provisional patent applications PR6345 and PR6366 filed 13 Jul. 2001, and the contents of both of said copending International patent applications and of their US national phase equivalents are incorporated herein by reference.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A fuel cell stack comprising alternating solid oxide fuel cell plates and gas separator plates stacked face to face within a housing, each of said fuel cell plates having an electrolyte layer with an anode layer on one side of the electrolyte layer and a cathode layer on an opposite side of the electrolyte layer, wherein each of said fuel cell plates has apertures therethough aligned with corresponding apertures through adjacent gas separator plates, a first aligned series of said apertures in the fuel cell plates and the gas separator plates opening to the respective anode side of each of the fuel cell plates to form a first manifold through which incoming fuel gas is distributed and a second aligned series of said apertures in the fuel cell plates and the gas separator plates opening from the respective anode side of each of the fuel cell plates to form a second manifold through which exhaust fuel gas is discharged from the stack, and wherein a third manifold is formed between the plates and the housing and opens to the respective cathode side of each of the fuel cell plates for distributing oxygen-containing gas to the fuel cell plates and a fourth manifold is formed between the plates and the housing and opens from the respective cathode side of each of the fuel cell plates for discharging exhaust oxygen-containing gas from the stack.

2. A fuel cell stack according to claim 1 wherein a third aligned series of said apertures in the fuel cell plates and the gas separator plates opens from the respective anode side of each of the fuel cell plates to form a further exhaust fuel gas manifold.

3. A fuel cell stack according to claim 2 wherein the first and second manifolds and the further exhaust fuel gas manifold are angularly spaced about the fuel cell plates and the gas separator plates.

4. A fuel cell stack according to claim 3 wherein the fuel cell plates and the gas separator plates are each generally circular with three lobes extending therefrom through which the apertures of the first, second and third aligned series of apertures respectively extend.

5. A fuel cell stack according to any one of claims 2 to 4 wherein each of the apertures of the first series of apertures has a greater cross-sectional area than each of the apertures of the second and third series of apertures.

6. A fuel cell stack according to any of claims 1 to 5 wherein a gas-tight seal extends around each of the apertures of the series of apertures, between said opposite side of each fuel cell plate and the adjacent gas separator plate.

7. A fuel cell stack according to claim 6 wherein each of said gas tight seals comprises a groove having a glass sealant in the bottom thereof in an upwardly facing surface of one of said fuel cell plate and said adjacent gas separator plate and a rib on the oppositely facing surface of the other of said fuel cell plate and said adjacent gas separator plate that closes the open top of the groove to retain the sealant in the groove.

8. A fuel cell stack according to claim 7 wherein the groove is formed between a pair of spaced ribs extending around the respective aperture in said upwardly facing surface.

9. A fuel cell stack according to any one of claims 1 to 8 wherein a respective gas-tight seal between said one side of each fuel cell plate and the adjacent gas separator plate extends around said plates outwardly of the apertures of said series of apertures through said plates.

10. A fuel cell stack according to claim 9 wherein said gas-tight seal comprises a groove having a glass sealant in the bottom thereof in an upwardly facing surface of one of said fuel cell plate and said adjacent gas separator plate and a rib on the oppositely facing surface of the other of said fuel cell plate and said adjacent gas separator plate that closes the open top of the groove to retain the sealant in the groove.

11. A fuel cell stack according to claim 10 wherein the groove is formed between a pair or spaced ribs on said upwardly facing surface.

12. A fuel cell stack according to any one of claims 1 to 11 wherein a further exhaust oxygen-containing gas manifold opening from the respective cathode side of each of the fuel cell plates is formed between the plates and the housing.

13. A fuel cell stack according to any one of claims 1 to 12 wherein the manifolds formed between the plates and the housing are separated by seals extending along the stack between the plates and the housing.

14. A fuel cell stack according to claim 13 wherein the seals are fibrous seals.

15. A fuel cell stack according to any one of claims 1 to 14 wherein the fuel gas flow across the anode layer of each of the fuel cell plates is in counter-flow to the oxygen containing gas flow across the cathode side of said fuel cell plate.

16. A fuel cell stack according to any one of claims 1 to 15 wherein the housing is cylindrical.

17. A fuel cell stack according to any one of claims 1 to 16 wherein the housing is constructed from sheet material formed of heat resistant steel.

18. A fuel cell stack according to any one of claims 1 to 17 wherein a respective current collector is provided between each adjacent pair of said fuel cell plates and said gas separator plates.

19. A fuel cell stack according to any one of claims 1 to IS wherein gas flow control formations are provided on the plates between each adjacent pair of said fuel cell plates and said gas separator plates.

20. A fuel cell stack according to claim 19 wherein the gas flow control formations act as current collectors.

21. A fuel cell stack according to any one of claims 1 to 20 wherein the solid oxide electrolyte is an yttria-stabilized zirconia and wherein each of said gas separator plates is formed at least substantially of zirconia.

22. A fuel cell stack according to claim 21 wherein the zirconia of the gas separator plates includes up to about 20 wt. % alumina.

23. A fuel cell stack according to claim 21 or claim 22 wherein each of said gas separator plates has electrically conductive paths therethrough from the anode-facing side to the cathode-facing side.

24. A fuel cell stack according to claim 23 wherein the material of the electrically conductive paths comprises silver.
